(19) United States
(12) Patent Application Publication
(10) Pub. No.: US 2019/0086572 A1
(43) Pub. Date: Mar. 21, 2019

(54) Apparatus and Method of Quasiperiodic Sequence Acoustic Isolator for Down-Hole Applications

(71) Applicant: GOWell International, LLC, Houston, TX (US)

(72) Inventors: Qinshan Yang, Katy, TX (US); Jensen Leung, Houston, TX (US)

(73) Assignee: GOWell International, LLC, Houston, TX (US)

(21) Appl. No.: 15/710,661

(22) Filed: Sep. 20, 2017

(51) Int. Cl. G01V 1/52; E21B 47/10; G01V 1/46

(52) U.S. Cl. CPC G01V 1/523; E21B 17/1078; G01V 1/46; E21B 47/101

(57) ABSTRACT

An isolator device and method for isolating frequencies. An isolator device may comprise a segment, wherein the segment comprises a first shell, wherein the first shell comprises a first end and a second end. The isolator device may further comprise an opening, wherein the opening is disposed within the at least one shell and wherein the opening is disposed in a quasi periodic sequence. A method for isolating frequencies may comprise attaching an isolator device to a downhole tool, inserting a downhole tool into a tube, wherein the downhole device comprises a sensor cartridge, broadcasting a signal into the tube, absorbing a reflected signal with the isolator, removing a frequency within the signal, and receiving the signal with the sensor cartridge.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

This invention relates to a field of acoustics, wherein data collection may be manipulated by changing the frequencies within signals that are being transmitted or received. Mechanical waves that travel through subterranean mediums are collected and studied to increase quality or performance. Specifically for down-hole logging applications, it may be used for imaging multiple tubes using non-destructive means. The changes and variations of tubing walls may be caused by internal and/or external patches, clamps, corrosions, erosions, and/or any combination thereof.

### BACKGROUND OF THE INVENTION

Oil and gas drilling of a subterranean formation may require a wellbore to facilitate the removal of minerals, fluids, gases, and oils. Running deep below the surface, a wellbore may have to resist high temperatures and pressures exerted upon it from underground formations. Often, defects may form within the wellbore and lead to the loss of minerals, fluids, gases, and oils as they are transported to the surface through the wellbore. Detecting defects within the wellbore may help personnel fix these defects.

Previous devices and methods that have been used to detect defects within a wellbore may not be able to detect smaller defects within a wellbore. Previous devices and methods have had problems with distinguishing incoming frequencies from the wellbore or straight from the transmitter to the receiver. A device that may minimize the signal trespassing from one area to another and control the frequency dampening band may provide more distinct information concerning the distribution of defects within a wellbore.

Thus, there is a need for an acoustic isolator which may be used to filter or absorb specific frequencies within a wellbore in order to collect precise data with less noise.

### BRIEF SUMMARY OF SOME OF THE PREFERRED EMBODIMENTS

These and other needs in the art may be addressed in embodiments by a system, device, and method for inspecting a tube.

An isolator device and method for isolating frequencies. An isolator device may comprise a segment, wherein the segment comprises a first shell, wherein the first shell comprises a first end and a second end. The isolator device may further comprise an opening, wherein the opening is disposed within the at least one shell and wherein the opening is disposed in a quasi periodic sequence.

A method for isolating frequencies may comprise attaching an isolator device to a downhole tool, inserting a downhole tool into a tube, wherein the downhole device comprises a sensor cartridge, broadcasting a signal into the tube, absorbing a reflected signal with the isolator, removing a frequency within the signal, and receiving the signal with the sensor cartridge.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection system wherein an isolator comprises a portion of a downhole tool;

FIG. 2 illustrates an embodiment of an inspection system wherein an isolator is clamped upon a portion of a downhole tool;

FIG. 3 illustrates an embodiment of an inner-view of an isolator;

FIG. 4 illustrates an embodiment of a layered isolator;

FIG. 5a illustrates an embodiment of a partial, inner view of an isolator;

FIG. 5b illustrates an embodiment of an expanded view of isolator;

FIG. 5c illustrates an embodiment of a quasiperiodic sequence;

FIG. 6 illustrates an embodiment of acoustical transmission;

FIG. 7a illustrates a graph of isolation-ratios; and

FIG. 7b illustrates a graph of isolation-ratios;

### DETAILED DESCRIPTION OF THE PREFERRED EMBODIMENTS

The present disclosure relates to embodiments of a device and method for dampening and/or removing selected frequencies from the broadcasting and receiving of acoustic noise. More particularly, embodiments of a device and method are disclosed for recording acoustical noise within a wellbore to determine the location of a defect within a wellbore. In embodiments, a downhole tool may be inserted into a wellbore using wireline technology. Within the wellbore, the downhole tool may produce vibrations along the wellbore wall using transmitters disposed in the downhole tool. Vibrations produced along the wellbore wall may create acoustic noise, which may be recorded by the downhole tool.

A sensor cartridge within the downhole tool may use any combination of sensors in which to detect acoustical noise within the wellbore. Acoustical noise may comprise signal waves which may be accomplished by sensors with a sensor cartridge. The signal wave data may be recorded, compiled, and analyzed to determine the location of defects within the wellbore wall. Determination of defects, detection of defects and/or transmission of data to the surface may be accomplished in real-time and may be performed as the downhole tool moves through the wellbore. In embodiments, the downhole tool may be removed from the wellbore before the recorded signal wave data may be compiled and analyzed.

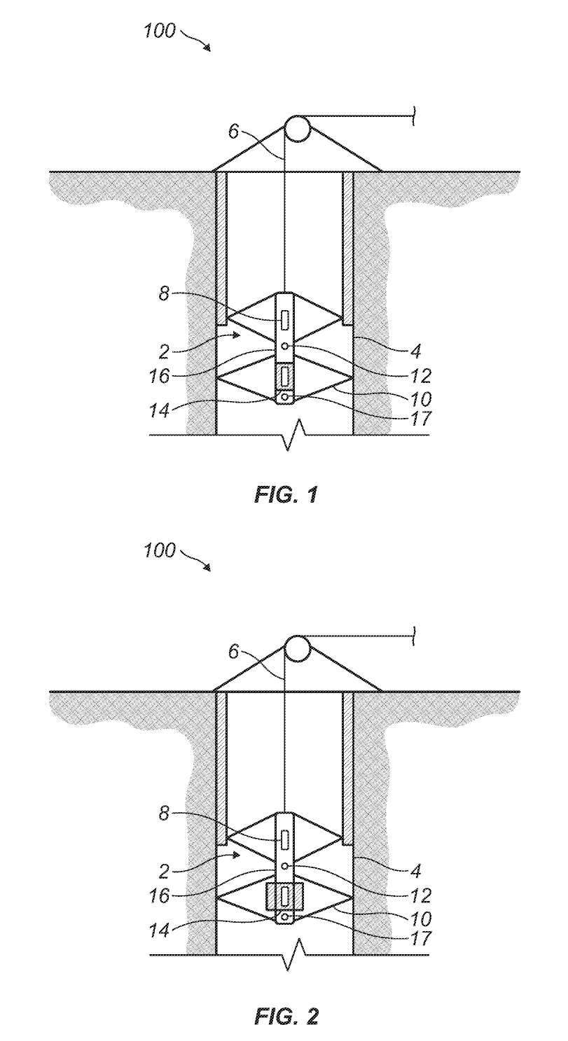

FIG. 1 illustrates a frequency dampening system 100, wherein a downhole tool 2 may be lowered into a wellbore 4 by a tether 6. In other embodiments, downhole tool 2 may be lowered into wellbore 4 by coiled tubing or any other suitable means, not illustrated. Downhole tool 2 may comprise a sensor cartridge 8, centralizers 10, a memory unit 12, an isolator 14, and a transmitter 17. Downhole tool 2 may also include any other desired components. In embodiments, there may be a plurality of sensor cartridges 8 disposed within downhole tool 2 at any suitable location. In embodiments, downhole tool 2 may be made of any suitable material to resist corrosion and/or deterioration from a fluid or conditions within wellbore 4. Suitable material may be, but is not limited to, titanium, stainless steel, plastic, and/or any combination thereof. Downhole tool 2 may be any suitable length and width in which to properly house components. A suitable length may be about one foot to about ten feet, about four feet to about eight feet, about five feet to about eight feet, or about three feet to about six feet. Additionally, downhole tool 2 may have any suitable width. A suitable width may be about one foot to about three feet, about one inch to about three inches, about three inches to about six inches, about four inches to about eight inches, about six inches to about one foot, or about six inches to about two feet.

Downhole tool 2 may comprise an outer housing 16. Outer housing 16 may protect downhole tool 2, and its comprising elements, from deterioration and corrosion from a fluid or conditions within wellbore 4. Outer housing 16 may be made of any suitable material. Suitable material may be, but is not limited to, titanium, stainless steel, plastic, and/or any combination thereof. Outer housing 16 may be any suitable length and width in which to properly house downhole tool 2. A suitable length may be about one foot to about ten feet, about four feet to about eight feet, about five feet to about eight feet, or about three feet to about six feet. Additionally, outer housing 16 may have any suitable width. A suitable width may be about one foot to about three feet, about one inch to about three inches, about three inches to about six inches, about four inches to about eight inches, about six inches to about one foot, or about six inches to about two feet.

Centralizers 10 may prevent downhole tool 2 from physically contacting wellbore 4, such as by running into, hitting, and/or rubbing up against wellbore 4. Additionally, centralizers 10 may be used to keep downhole tool 2 properly oriented within wellbore 4. Centralizers 10 may attach to outer housing 16 at any desirable location. A desirable location may be about an end of outer housing 16, about the center, and/or between the center and an end of outer housing 16. In embodiments, there may be a plurality of centralizers 10. In embodiments as illustrated, a centralizer 10 may be disposed at about opposing ends of outer housing 16. Centralizers 10 may be made of any suitable material. Suitable material may be but is not limited to, stainless steel, titanium, metal, plastic, rubber, neoprene, or any combination thereof.

Transmitter 17 may broadcast a signal into wellbore 4. Transmitter 17 may be disposed at any location within downhole tool 2. In embodiments, there may be a plurality of transmitters 17 within downhole tool 2. Transmitter 17 may enact monopole, dipole, and/or quadrupole excitation for signal generation. Transmitter 17 may comprise piezoelectric transducers that may generate an acoustic signal. In embodiments, any acoustic source that provides a suitable signal may be used. The signal may be recorded by sensors located within sensor cartridges 8.

Sensor cartridge 8 may be disposed at any location within downhole tool 2. In embodiments, there may be a plurality of sensor cartridges 8 within downhole tool 2. Sensor cartridge 8 may comprise any type and any number of sensors (not illustrated) suitable for detecting acoustic noise. Suitable sensors may include, but are not limited to, monopoles, dipoles, and/or quadrupoles. In embodiments, sensors may be defined as monopole, dipole, and/or quadrupoles based upon the number of sensor surfaces that are connected. Sensor surfaces may be comprised of any suitable material such as piezoceramic material, ferroelectric, lead titanate, lead zirconate, lead metaniobate, or any combination thereof. In embodiments, sensor surfaces include piezoceramic material. Piezoceramic material may be used to record noise generated within a wellbore 4. Sensor cartridge 8 may have a plurality of different sensors, arranged in any order. The arrangement of sensors may allow for downhole tool 2 to search for defects within wellbore 4 walls.

As downhole tool 2 moves through wellbore 4, it may record acoustic noise created from fluid leaking through or behind a casing, flowing fluid channel noise, sand jet entry into a wellbore 4, perforation production, and/or fluid filtration within a formation. Acoustic noise properties may be recorded and analyzed. Specific properties recorded and analyzed may be frequency, amplitude, acoustic mode (compress, shear, etc.), propagation direction, velocity, location azimuthal, and/or distribution of the noise from a source point. This information may be stored on a memory unit 12, as illustrated in FIG. 1, which may provide in tool memory and may comprise flash chips and/or ram chips which may be used to store data and/or buffer data communication. Stored data may be transferred to the surface in real-time through tether 6 to the surface. In embodiments, data may be transferred as downhole tool 2 is moving through wellbore 4 and/or while downhole tool 2 is in a fixed position. In embodiments, data may be stored on memory unit 12 until downhole tool 2 has been removed from wellbore 4.

Recorded acoustic waves may be analyzed by information handling systems (not illustrated) to determine properties of wellbore 4. Without limitation, information handling systems may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling systems may be a personal computer, a network storage device, or any other suitable device and may vary in size, shape, performance, functionality, and price. Information handling systems may include random access memory (RAM), one or more processing resources such as a central processing unit (CPU) or hardware or software control logic, ROM, and/or other types of nonvolatile memory. Additional components of information handling systems may include one or more disk drives, one or more network ports for communication with external devices as well as various input and output (I/O) devices, such as a keyboard, a mouse, and a video display. In embodiments, information handling systems may process information on the surface and/or downhole.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

The resolution quality of data acquired from acoustic methods used for imaging is a function of the signal wavelength. For example, longer wavelengths are able to travel further across mediums, such as subterranean formations, and collect more data in a downhole environment. Therefore, longer wavelength-producing devices are desired for data collection. These devices emit signals at various frequencies. Since, the relationship between wavelength and frequency of a signal is inversely proportional, lower frequencies are desired for acoustic data acquisition. With current advances in technology, these devices are limited in how low they can produce frequencies. A problem that occurs between communication systems is the noise produced by all of the various frequency signals being recorded within wellbore 4. Depending on the type of transmitting device, signals may travel directly from transmitter 17 to sensor cartridge 8 without first reflecting off formations in wellbore 4. This may distort or skew the data being collected on wellbore 4. A way to mitigate the issue would be to isolate and prevent signals with certain frequencies from being recorded by sensor cartridge 8. Consequently, downhole tool 2 may further comprise of an isolator 14.

Isolator 14 may minimize the signal produced by transmitter 17 and may also dampen the signal of a specific frequency band. With current technology, transmitter 17 may produce signals within a frequency threshold. Isolator 14 may be implemented to further decrease that signal to an ideal frequency. Without limitation, the frequency band isolator 14 may be exposed to may be about one kHz to about forty kHz. For example, frequencies may range from about one kHz to about twelve kHz, about twelve kHz to about twenty-five kHz, or about twenty-five kHz to about forty kHz. Isolator 14 may affect sound waves travelling inside of downhole tool 2 through outer housing 16 to wellbore 4 or from the outside of outer housing 16 into downhole tool 2. In embodiments, isolator 14 may be used to remove a frequency within the signals that sensor cartridges 8 may receive. Isolator 14 may absorb a reflected signal within wellbore 4. There may be a plurality of signals generated from transmitter 17, each at different frequencies due to energy loss as the signals travel. Isolator 14 may make it easier for data analysis for a specific frequency, or frequency band, by allowing a specified frequency to pass through to sensor cartridges 8.

Isolator 14 may be disposed as a part of, or in line with, outer housing 16 of downhole tool 2, as illustrated in FIG. 1. Without limitation, isolator 14 may be disposed as a part of, or in line with, outer housing 16 through the use of threading, adhesives, welding and/or any combination thereof. Isolator 14 may be disposed at any position along the central axis of outer housing 16. Isolator 14 may be disposed about an end, about the center, or any position in between outer housing 16. Isolator 14 may be long enough to cover the entire length and/or at least a portion of outer housing 16. In embodiments, there may be a plurality of isolators 14 disposed as a part of, or in line with, outer housing 16 that may cover at least a portion of a plurality of sensor cartridges 8. There may be space between a plurality of isolators 14, or a plurality of isolators 14 may be attached to each other. Isolator 14 may be any suitable length that may cover at least a portion of the aforementioned devices. Without limitation, the length of isolator 14 may be about six inches to about eight feet. For example, the length may be about six inches to about one foot, about one foot to about three feet, about three feet to about five feet, or about five feet to about eight feet. Isolator 14 may be able to be elongated by disposing another isolator 14 on one end. Without limitation, isolators 14 may attach to each other through the use of threading, a snap-fit method, adhesives, welding and/or any combination thereof Isolator 14 may be any suitable shape. Without limitation, a suitable shape may be circular, elliptical, triangular, rectangular, square, hexagonal and/or any combination thereof. Isolator 14 may comprise any suitable materials that function for damping energy. Without limitation, suitable materials may be metals, polymers, rubbers, composites and/or any combination thereof.

FIG. 2 illustrates an embodiment wherein isolator 14 may be disposed around outer housing 16. The inner face of isolator 14 may be disposed upon an outer face of outer housing 16. Without limitation, isolator 14 may be disposed around outer housing 16 through the use of threading, adhesives, welding and/or any combination thereof Isolator 14 may be disposed at any position along the outer housing 16 central axis. Isolator 14 may be disposed about an end, about the center, or any position in between outer housing 16. Isolator 14 may be long enough to cover the entire length or at least a portion of outer housing 16. In embodiments, there may be a plurality of isolators 14 disposed around outer housing 16 that may cover a plurality of sensor cartridges 8. There may be space between the locations of a plurality of isolators 14, or a plurality of isolators 14 may be disposed upon each other. Isolator 14 may be any suitable length that may cover at least a portion of the aforementioned devices.

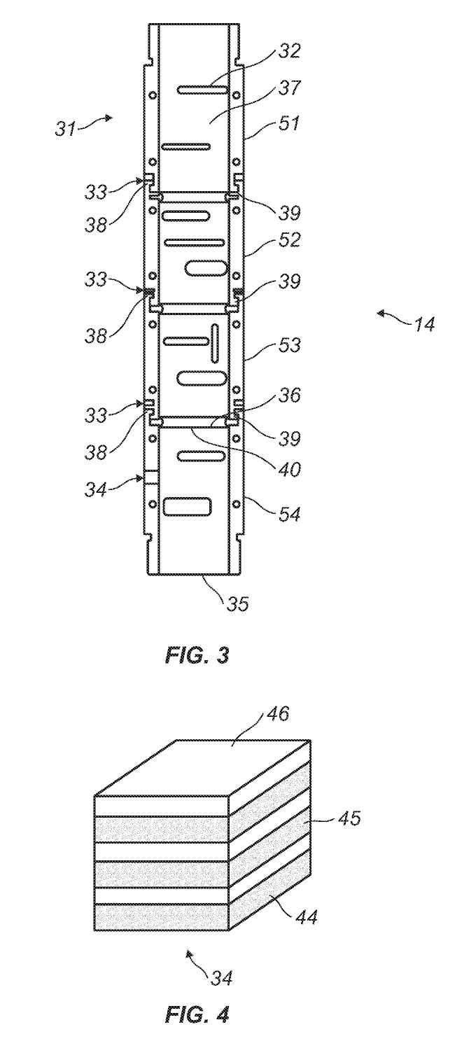

As illustrated in FIG. 3, isolator 14 may comprise a segment 31, a first segment 51, a second segment 52, a third segment 53, a fourth segment 54, an opening 32, an insulating material 33, a cross-section 34, a first end 35, a second end 36, a shell 37, a first bent arm extension 38, and a second bent arm extension 39. Isolator 14 may comprise a plurality of segments 31. Each respective segment 31 may comprise at least a portion of isolator 14. Segment 31 may comprise first end 35 and second end 36. First end 35 and second end 36 may be disposed at opposing sides of segment 31. First end 35 may function as a connection point between first segment 51 to outer housing 16 and/or between first segment 51 and second segment 52. In other embodiments, first end 35 may function as a connection point between subsequent segments (i.e. second segment 52 to third segment 53, third segment 53 to fourth segment 54, etc.). Second end 36 may function as a connection point between first segment 51 to outer housing 16 and/or between first segment 51 and second segment 52. In other embodiments, second end 36 may function as a connection point between subsequent segments (i.e. second segment 52 to third segment 53, third segment 53 to fourth segment 54, etc.). First end 35 and second end 36 may be used interchangeably. First end 35 may comprise first bent arm extension 38 or second bent arm extension 39. Second end 36 may comprise first bent arm extension 38 or second bent arm extension 39. First bent arm extension 38 and second bent arm extension 39 may serve as the mechanically affixing contact point between first segment 51 and second segment 52. In other embodiments, first bent arm extension 38 and second bent arm extension 39 may serve as the mechanically affixing contact point between subsequent segments (i.e. second segment 52 to third segment 53, third segment 53 to fourth segment 54, etc.). Without limitation, first segment 51 may attach to second segment 52 or to outer housing 16, through the use of threading, a snap-fit method, adhesives, welding and/or any combination thereof.

Segment 31 may be any suitable length that can cover at least a portion of sensor cartridge 8. Without limitation, the length of segment 31 may be about six inches to about eight feet. For example, the length may be about six inches to about one foot, about one foot to about three feet, about three feet to about five feet, or about five feet to about eight feet.

Segment 31 may comprise a shell 37. Segment 31 may comprise a plurality of shells 37. Shell 37 may attach to another shell 37 to form a segment 31 through suitable fasteners. In embodiments, any number of shells 37 may attach to each other to form segment 31. Without limitation, suitable fasteners may be nuts and bolts, washers, screws, pins, sockets, rods and studs, hinges and/or any combination thereof. In other embodiments, segment 31 may comprise disks and/or other solid parts, not illustrated. Shell 37 may comprise a fin. Shell 37 may comprise a plurality of fins. The fins may be disposed along the vertical sides of shell 37, not illustrated. It should be noted that the fins may be disposed along any suitable axis of shell 37. The fins may serve as fastener locations in order to attach shell 37 to another shell 37.

In FIG. 3, the cross-section 34 may comprise of multiple layers. Cross-section 34 may comprise of layers to control the acoustic signal damping frequency band and to isolate acoustic signals from one area to other adjacent areas. As illustrated in FIG. 4, these layers may comprise an outer layer 46, an intermediate layer 45, and an inner layer 44. Outer layer 46 may protect the rest of segment 31 from external damage. There may be a plurality of intermediate layers 45. Inner layer 44 may be formed to be disposed around outer housing 16 or to encompass devices disposed in downhole tool 2 (referring to FIG. 1). Each layer of segment 31 may comprise any suitable materials that functions for dampening energy. Without limitation, suitable materials may be metals, polymers, rubbers, composites and/or any combination thereof. In embodiments, the layers of segment 31 may comprise of stainless steel, rubber, Teflon, PEEK, and silicone oil (i.e. silicone oil 100 cs or 1000 cs). The aforementioned layers of segment 31 may be any suitable shape. Without limitation, a suitable shape may be circular, elliptical, triangular, rectangular, square, hexagonal, semi-circular, a straight line and/or any combination thereof.

Segments 31 may comprise insulating material 33 which may be disposed between each segment 31. Insulating material 33 may be used to further distort a sound wave's path. Sound waves travel through mediums by vibrating the molecules within that medium. The elastic properties and densities of different mediums further affect the sound wave. Insulating material 33 may help isolator 14 maintain mechanical strength and promote effective acoustic logging. Insulating material 33 may be disposed between first bent arm extension 38 and second bent arm extension 39. Insulating material 33 may comprise of any suitable materials. Without limitation, suitable materials may be metals, polymers, rubbers, composites and/or any combination thereof In embodiments, insulating material 33 comprises of different arrangements of rubber, PEEK, and steel. Insulating material 33 may be any suitable shape. Without limitation, a suitable shape may be circular, elliptical, triangular, rectangular, square, hexagonal and/or any combination thereof.

Insulating material may also comprise of connecting material 40. Connecting material 40 may run the length of the circumference of isolator 14 in order to dampen signals that may travel along the length of multiple segments 31. Connecting material 40 may also comprise at least a portion of the circumference of isolator 14. Connecting material 40 may be disposed between first end 35 and second end 36. Connecting material may comprise of any suitable material. Without limitation, suitable material may be metals, polymers, rubbers, composites and/or any combination thereof. In embodiments, connecting material 40 comprises of PEEK, PTFE, rubber, or any polymer that may have a different density than first end 35 and second end 36.

Segments 31 may comprise of opening 32. Opening 32 may be the absence of material in an object. Opening 32 may serve to disrupt a potential sound wave's path of motion, thereby altering its frequency. Opening 32 may permit communication between designated areas. In embodiments, there may be a plurality of openings 32 disposed on segment 31. In embodiments, openings 32 may be cut and designed to alter and/or prevent the movement of frequencies along segment 31. Openings 32 may be any suitable shape. Without limitation, a suitable shape may be a line, circular, elliptical, triangular, rectangular, square, hexagonal and/or any combination thereof. In embodiments, openings 32 may comprise of thin slotted lines, elongated ellipses, rounded rectangles and/or any combination thereof. Openings 32 may be aligned along any direction along any axis within isolator 14. In embodiments, openings 32 may be aligned perpendicular and/or parallel to the vertical axis of isolator 14 as illustrated in FIG. 3.

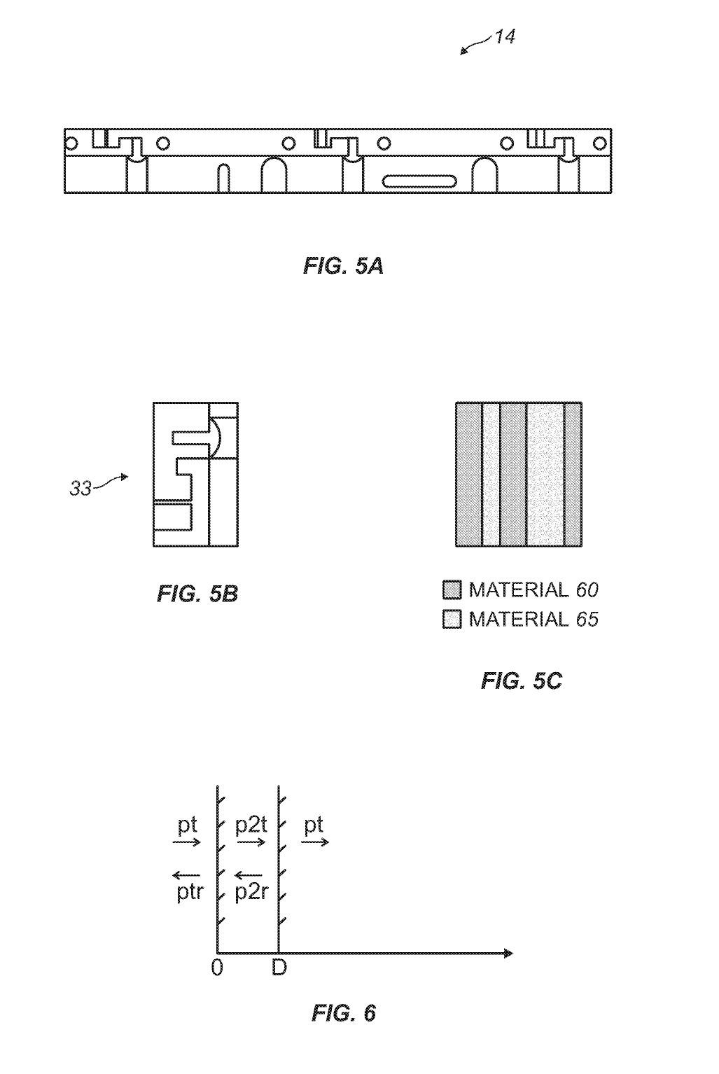

The positioning of openings 32 and insulating material 33 may be disposed in a quasiperiodic sequence, wherein any one period is virtually identical to its adjacent periods but not necessarily similar to periods farther away. Without limitation, a quasiperiodic sequence may be a Fibonacci sequence. In embodiments, different sequences of the properties of insulating material 33 and openings 32 may exhibit a quasiperiodic sequence. For example, the position and/or thickness of insulating material 33 may be arranged in a Fibonacci sequence. In other embodiments, the shape and orientation of opening 32 along the central axis of segment 31 may also be arranged in a Fibonacci sequence. FIG. 5(a) illustrates a partial, inner view of isolator 14. FIG. 5(b) illustrates an expanded view of a portion of FIG. 5(a) highlighting the sequence of insulating material 33. FIG. 5(c) illustrates an embodiment of a quasiperiodic sequence depicting how the sizes of Material 60 and Material 65 change as the sequence progresses, wherein Material 60 and Material 65 may be any suitable material. Without limitation, suitable material may be metals, polymers, rubbers, composites and/or any combination thereof.

The unique shape and positioning of openings 32 and insulating material 33 may affect acoustic transmission, the degree to which sound may be transferred between mediums depending on how well their acoustical impedances match, into sensor cartridge 8 (referring to FIG. 1). In embodiments, the acoustic transmission factor may be disclosed below:

$$\begin{matrix}{t}_{I} = \frac{4}{4 {cos}^{2} {k}_{2} D + {( {Z}_{12} + {Z}_{21} )}^{2} {sin}^{2} {k}_{2} D} & ( 1 ) \\ {Z}_{12} = {Z}_{1} \text{/} {Z}_{2 ;} & ( 2 ) \\ {Z}_{21} = {Z}_{2} \text{/} {Z}_{1 ;} & ( 3 )\end{matrix}$$

As noted in Equation 1, the acoustic intensity transmission factor on the interface (t₁) is dependent on the following factors: wavenumber of the second layer (k₂), thickness of the second layer (D), acoustic impedance of the first layer with respect to the acoustic impedance of the second layer (Z₁₂), and acoustic impedance of the second layer with respect to the acoustic impedance of the second layer (Z₂₁). Wherein, Z₁₂ and Z₂₁ may be disclosed in Equation 2 and Equation 3 respectively. Equations 2 and 3 may relate the acoustic impedance of the first layer (Z₁) to the acoustic impedance of the second layer (Z₂).

FIG. 6 illustrates an embodiment of an acoustic wave travelling through different layers of isolator 14, as illustrated in FIG. 3. As the wave travels a certain distance and passes through the different layers (e.g. outer layer 46, intermediate layer 45, and inner layer 44), the wave properties may change due to the reflection of different frequencies at various layers. These physical responses in the wave's properties reduce its available energy. This, in turn, alters the wave's frequency, which is being used by acoustic logging systems to collect quality data concerning wellbore formations.

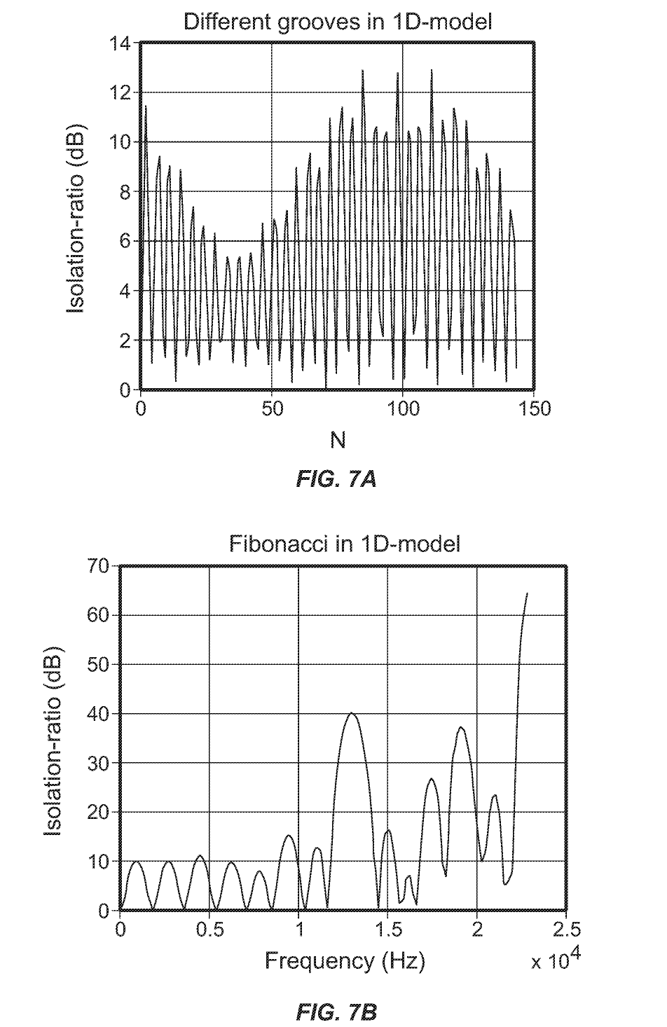

FIG. 7 illustrates results of acoustic logging with the implementation of an embodiment of isolator 14. FIGS. 7(a) and 7(b) may show the isolation-ratios of embodiments. Both figures illustrate examples of isolator 14 only dampening the noise in the desired working frequency. FIG. 7(a) illustrates the processing of an incoming eight kHz signal as it has passed through a number of rock and fluid formations. FIG. 7(b) illustrates how the isolation-ratio of a working frequency between about ten kHz to about fifteen kHz is thirty dB higher than in other frequency ranges. Both figures illustrate distinct peaks and valleys of signals generated within a downhole environment as a result of being processed by isolator 14 (referring to FIG. 1). Otherwise, a significant amount of noise would be present in data being analyzed without the use of a device that attenuates signals.

Although the present invention and its advantages have been described in detail, it should be understood that various changes, substitutions and alterations may be made herein without departing from the spirit and scope of the invention as defined by the appended claims.

1. An isolator device, comprising:
a segment, wherein the segment comprises a first shell, wherein the first shell comprises a first end and a second end.
an opening, wherein the opening is disposed within the at least one shell and wherein the opening is disposed in a quasi periodic sequence.

2. The isolator device of claim 1, wherein the segment comprises a second shell, wherein the second shell is attached to the first shell.

3. The isolator device of claim 2, wherein a plurality of openings are disposed in the quasi periodic sequence on the first shell and the second shell.

4. The isolator device of claim 1, wherein the isolator comprises a first segment and a second segment, wherein the first segment and the second segments comprise at least one shell.

5. The isolator device of claim 4, wherein the first end is a first segment attachment, wherein the first segment attachment comprises a first bent aim extension, wherein the second end is a second segment attachment, wherein the second segment attachment comprises a second bent arm extension.

6. The isolator device of claim 5, wherein the first bent arm extension is attached to the second bent arm extension.

7. The isolator device of claim 1, wherein a first segment and a second segment are attached by a first bent arm extension and a second bent arm extension and wherein an insulating material is disposed between the first bent arm extension and the second bent arm extension.

8. The isolator device of claim 7, wherein the insulating material is a plurality of material, wherein the plurality of material are rubber, PEEK, or steel.

9. The isolator device claim 8, wherein the plurality of material is disposed in the quasi periodic sequence between the first bent arm extension and the second bent arm extension.

10. The isolator device of claim 1, wherein the first end is an outer housing attachment and the second end is a segment attachment.

11. The isolator device of claim 1, wherein the first end is a first outer housing attachment and the second end is a second outer housing attachment.

12. A method for isolating frequencies, comprising:
(A) attaching an isolator device to a downhole tool;
(B) inserting a downhole tool into a tube, wherein the downhole device comprises a sensor cartridge;
(C) broadcasting a signal into the tube;
(D) absorbing a reflected signal with the isolator;
(E) removing a frequency within the signal; and
(C) receiving the signal with the sensor cartridge.

13. The method of claim 12, wherein the attaching an isolator device to a downhole tool comprises the isolator device is at least a portion of an outer housing of the downhole tool.

14. The method of claim 12, wherein the attaching an isolator device to a downhole tool comprises the isolator device is disposed on the outer surface of the outer housing of the downhole tool.

15. The method of claim 12, wherein the isolator device is disposed over at least a portion of the sensor cartridge.

16. The method of claim 12, wherein the absorbing a reflected signal with the isolator is performed by a plurality of openings wherein the plurality of openings are disposed in a quasi periodic sequence.

17. The method of claim 16, wherein the quasi periodic sequence is a Fibonacci Sequence.

18. The method of claim 12, wherein the attaching an isolator device to a downhole tool further comprises attaching a first segment to a second segment.

19. The method of claim 18, wherein the first segment and the second segment comprise a first arm extension and a second arm extension and wherein the first arm extension and the second arm extension attach the first segment to the second segment.

20. The method of claim 19, wherein a plurality of material is disposed between the first segment and the second segment.
